(19) United States
(12) Patent Application Publication
(10) Pub. No.: US 2021/0021130 A1
(43) Pub. Date: Jan. 21, 2021

(54) SYSTEMS AND METHODS FOR DISTRIBUTED HIERARCHICAL ARTIFICIAL INTELLIGENCE IN SMART GRIDS

(71) Applicant: BluWave Inc., Ottawa (CA)

(72) Inventors: Mostafa FARROKHABADI, Ottawa (CA); Parham MOMTAHAN, Ottawa (CA); Devashish PAUL, Ottawa (CA)

(73) Assignee: BluWave Inc., Ottawa (CA)

(21) Appl. No.: 16/931,794

(22) Filed: Jul. 17, 2020

Related U.S. Application Data
(60) Provisional application No. 62/876,214, filed on Jul. 19, 2019.

(51) Int. Cl. H02J 3/06; H02J 3/28; G06N 20/00; G01W 1/00

(52) U.S. Cl. CPC H02J 3/06; H02J 3/28; H02J 2203/10; G01W 1/00; G06N 20/00

(57) ABSTRACT

Systems and methods are described for distributed hierarchical artificial intelligence (AI) in smart grids using two levels. At a higher level, the AI center module sits at the high-voltage transmission or distribution substation level, and manages a few points of aggregations (POA). At a lower hierarchy, each POA consists of all controllable and non-controllable elements in distribution feeder, distribution transformer, or microgrid level. These elements include distributed energy resources, energy storage systems, residential and commercial energy management systems, electric vehicle charging stations, etc. Each POA may be logically and/or physically connected to other POAs. Within each POA, AI edge module calculates the optimal disaggregation of set-points received from the AI center module to the controllable elements based on local information, and information gathered from the AI center module.

### CROSS REFERENCE TO RELATED APPLICATIONS

This application claims the benefit of U.S. Provisional Application No. 62/876,214, filed Jul. 19, 2019, which is incorporated by reference herein in its entirety.

### BACKGROUND

The term “smart grids” generally refers to grids of numerous heterogeneous agents that are coordinated in a holistic manner to provide an autonomous, stable, and reliable electricity generation, transmission, and delivery. Such grids contain diverse generation, transmission, and consumption components ranging from centralized power plants to distributed renewable energies, high voltage transmission lines to low voltage distribution feeders, large-scale electricity storage units to residential thermal storages, and nation-wide power flow management to residential energy management systems.

The level of grid autonomy, reliability, and optimality of operation depends on the effectiveness of its monitoring, control, and protection methods. Today, smart grids are characterized by a bi-directional flow of electricity and information and leverage distributed computing and communications to deliver real-time information and enable near-instantaneous corrective actions.

Smart grids are typically characterized by a high penetration of distributed generation, consumption, and metering devices. These include wind, solar, hydro, tidal, and thermal generation units, electric vehicles, microgrids, residential smart meters, etc. Control and optimization of all these elements require exchanging an enormous volume of data and metering information that should be ingested, inferred, and reflected upon. In this context, big data analytics, in particular artificial intelligence methods are a key enabler of fully autonomous smart grids.

The automation being applied to smart grids is similar in concept to the network management and operations support systems that were applied to the telecommunications network in the 1970s and 1980s. However, applying IT and communications technology to the grid is not straightforward because it must account for constraints that did not exist in automating the telecommunications network. It is desirable that the unique challenges of the grid are addressed in the automation of the grid.

### SUMMARY

In an embodiment, a system for operation of an electric grid includes an artificial intelligence (AI) center module configured to control a point of aggregation (POA) using information received from at least one of an upper grid, the point of aggregation, and one or more external sources to the electric grid. The system further includes an AI edge module in the POA, wherein the AI edge module is configured to calculate an optimal disaggregation of set points received from the AI center module to one or more controllable elements based on at least one of local information and information from the AI center module.

In an embodiment, a method for operation of an electric grid includes controlling, using an artificial intelligence (AI) center module, a point of aggregation (POA) using information received from at least one of an upper grid, the point of aggregation, and one or more external sources to the electric grid. The method further includes calculating, using an AI edge module in the POA, an optimal disaggregation of set points received from the AI center module to one or more controllable elements based on at least one of local information and information from the AI center module

Further embodiments, features, and advantages of the invention, as well as the structure and operation of the various embodiments, are described in detail below with reference to accompanying drawings.

### BRIEF DESCRIPTION OF THE DRAWINGS

The accompanying drawings are incorporated herein and form a part of the specification.

FIG. 1 is a block diagram of an example system for implementing a multi-level distributed hierarchical artificial intelligence system in smart grids, according to some embodiments.

FIG. 2 is another block diagram of an example system for implementing a multi-level distributed hierarchical artificial intelligence system in smart grids, according to some embodiments.

FIG. 3 is an example computer system useful for implementing various embodiments.

In the drawings, same reference numbers generally indicate identical or similar elements.

Additionally, generally, the left-most digit(s) of a reference number identifies the drawing in which the reference number first appears.

### DETAILED DESCRIPTION

In electrical power networks, the generation, distribution and consumption of electrical energy are the important functions of these systems. Modern electrical power networks, such as smart grids, have bi-directional movements of both electricity and data/control messages throughout the network. Smart grids employ real-time monitoring and control of energy flow throughout the network, and such networks are typically distributed over a large geographic area. Within the network are a wide diversity of nodes that include energy sources, energy consumers, as well as various monitoring devices. The energy sources in smart grid networks may include conventional energy sources, as well as renewable energy resources. The energy consumers in smart grid networks include conventional energy consumption devices, as well as smart appliances. The monitoring devices in smart grid networks include conventional power meters, as well as smart meters. It is desirable to secure various advantages in smart grid networks, such as improved efficiency, economy, reliability, security and safety through real-time monitoring and controlling of the movement of power and associated performance data.

Modern power networks have an ever increasing number of connected devices, a trend that will continue with the Internet of Things (IoT). Such connected devices offer fine-grained energy data that captures the details of real world energy generation, distribution and consumption through the network. This “big data” opportunity offers new prospects for enhanced power network control provided the relevant data can be analyzed in real-time such that decisions may be made and actions taken. Analytical approaches applied to the available data in smart grids offer enhanced decision making, as well as an opening of the door to innovative applications. However, to provide the best platform for these new prospects, the inventors recognized the need for an appropriate network architecture to support optimal energy data aggregation and control functionality. Data aggregation may include aggregation of the data at aggregation points from similar data sources, such as smart meters, electric vehicle charging stations, roof-top solar cells, weather stations, etc. Such real-time data in its aggregated form may be combined with predictive analytics and other functionality scenarios to optimize the set points of power utilization within the smart grid.

Initial attempts to apply automation to smart grids are similar in concept to the network management and operations support systems that were applied to the telecommunications network in the 1970s and 1980s. However, applying information technology (IT) and communications technology to the grid is not straightforward because it must account for constraints that did not exist in automating the telecommunications network. It is desirable that the unique challenges of the grid are addressed in the automation of the grid. Unlike the telecommunications network, which routes packets of information, the electric grid routes power flows that are complex to direct. Furthermore, unlike the routing of packets of information, the delivery of electric power does not offer the ability to “buffer” excess power. Instead, supplied electric power must instantaneously match the demand for that power. Excess or deficit of power needs to be accommodated in real-time with energy storage. Such real-time requirements impose tight latency requirements on the grid network and its control capabilities. For example, some smart grid applications, such as supervisory control and data acquisition (SCADA) systems that control generators or substations, have latency requirements measured in milliseconds and the consequences of failing to deliver a control packet on time can be catastrophic. Other applications in the smart grid, such as communication of smart meter interval data, have much less stringent requirements. Characterizing the performance requirements for the various smart grid applications is critical to understanding which communications technologies should be used for various applications.

The inventors considered a number of factors in conceiving an innovative approach to the next generation of smart grid design. Such factors included the architecture, processing distribution design, data analysis and aggregation approach, control methodology and latency design considerations. At the outset, the inventors have noted that the communication infrastructure that supports the operation of modern power grids needs fundamental changes. The legacy control and optimization architecture was designed to meet the needs of a regulated power industry that dates from several decades ago. This legacy approach offers a limited ability to cope with the new requirements of the smart grid in terms of penetration, scalability, and performance. Moreover, various considerations in the area of active control suggest a shift is needed from the centralized control model toward a more distributed control paradigm. Given the scale and scope of the systems being considered, with thousands or even millions of potential end users on the network, the architecture for a smart grid computing and communication system must be carefully designed. In particular, the development of a distributed management and data aggregation model will be critical to making the system scalable and responsive to localized changes.

Processing Design Considerations

One factor considered by the inventors in their innovative approach is the design of the processing implementation. A key factor of a new smart grid system will be the need for some significant “back-end” processing services to support dynamic analysis of the incoming monitoring statistics and to provide updated information to the management entities and administrators. This will require the provision of on-demand computing facilities capable of dealing with this volume of data. A natural way to fulfill this need would be through cloud computing. Furthermore, for any system to be deployable over the entire network, it must be sufficiently simple and scalable to be seen as a worthwhile investment. This is a highly complex issue and the design must include the cost of equipment in the core and edge, administrative and training overheads, development and maintenance costs, and many other factors. This is because the system must be viewed in its entirety, not in isolation. One potential solution to the processing design challenges is to adopt a hierarchical approach. Another consideration is to add a machine learning inference module to each collector node and the backhaul node in a smart grid network.

Data Analysis and Aggregation Design Considerations

Other factors considered by the inventors include looking at centralized and de-centralized techniques with the need for an approach that combines features from both. At present, control and optimization based on historical data and machine learning occurs in a centralized SCADA systems. There are also possibilities for using distributed big data management in smart grids using fog computing methods, with the progress in the application of artificial intelligence machine learning for prediction and control being distributed to the edge. Fog computing is an extension of cloud computing to the edge of a network, such that services are provided closer to near-user edge devices, instead of sending data to the cloud.

Based on the above considerations, and due to numerous heterogeneous agents operating in the context of smart grids, the inventors noted the need for centralized approaches to aggregate agents with similar characteristics to reduce the intake of data and computational burden. It is further noted that the process of aggregation results in the loss of useful data and a reduction in the observability of the system status, thus decreasing the controllability as well. On the other hand, fully distributed approaches have a complex design and implementation, and suffer from communication delays, inferior performance in presence of uncertainties, and absence of authority during emergency events.

Control Design Considerations

There are generally three approaches, centralized, decentralized, and fully distributed, which the inventors analyzed for control design suitability in an innovative smart grid. The advantages and disadvantages of these approaches are as follows. Using distributed control to build adaptively to the changing circumstances of a smart grid needs to deal with the scale of millions of devices. Centralized control (within the communication-based smart grid (CBSG) framework) is clearly limited due to scaling difficulties. On the other hand, a decentralized approach cannot achieve global optimality and stability. Looking back at classical power system control, many controls are decentralized for basic operation, but for recovery, more centralized systems prevailed. This trade-off between centralized versus decentralized approaches is new to low voltage (LV) networks and is complicated by the huge number of devices to be coordinated in these networks. The issue of scaling is an important consideration in the field of computer science algorithms for optimization, sorting and the like. In developing innovative solutions to modern smart grid networks, the inventors evaluated the use of techniques derived by combining optimization with learning ideas.

With respect to the considerations of control for large-scale systems, both the synthesis and the implementation of a centralized controller are often impossible in practice. Firstly, a large-scale system may have a huge number of states, inputs and outputs, and classical optimal control design algorithms usually cannot handle such a design problem. Secondly, in many systems, subsystems are geographically distributed. Thus, to implement a centralized control scheme, unknown variations of the original interconnection topology of the system are inevitable. In response to these concerns, decentralized control methods have been proposed where information transferring between certain groups of sensors or actuators is restricted. This characteristic may reduce the implementation and calculation complexity of the control laws. But the drawbacks are that such controllers may need more “intelligence” to handle uncertainties, and performances of systems with decentralized controllers may be not as good as those of systems with centralized controllers.

In order to strike a balance between centralized control and decentralized control, distributed control has been explored. In distributed control, each controller can receive a restricted subset of sensor signals from neighboring subsystems and the control algorithms are calculated based on all of these available information. However, distributed control has its own disadvantages: it requires communication infrastructure between agents, and as the system size grows, the communications delay as well as the complexity of the control technique may grow beyond practical implementation.

Latency Design Considerations

Latency in a grid network includes at least two types of latency: computational latency and communication latency. Computational latency, the delay in completion of computations used when computing various grid functions (e.g., optimization functions, control functions) are greatest in a centralized network architecture. This is because a centralized architecture collects the data received from various places, including the edge nodes of the network, and then proceeds to analyze the data in a single location, namely at the root node of the network. From the data analysis and/or optimization, various settings may be determined, which are then promulgated throughout the network. With ever increasing penetration and complexity of modern day electric power networks, the computational load demands are such that the computational times may not be feasibly achieved in the timeframes needed to ensure that the desired control of the electric power network is achieved.

Communication latency reflects the delay in communication of data, such as control data or messaging, from one node to another node in a network. In a fully distributed network, such as a mesh network, each node may be in communication with its neighboring nodes. Communication between a node and any other node may proceed by way of the intervening nodes, with the delays associated with stepping from one node to the next node until reaching the final destination node. In a large mesh node with many nodes, the communication latency may be substantial in various worst case scenarios where the two communicating nodes lie at diametric opposite nodes in the network.

Insights by the inventors have examined the latency characteristics of various network architecture designs that are suitable for smart grids. Rather than centralizing all of the computation in the root node of a centralized solution, a multi-level hierarchy solution enables distribution of the computational workload. Such an architecture provides a distribution of computational workload such that a form of computational parallelism is deployed.

Also, in a distributed control scheme, each system performs optimization only on its own control inputs, with the assumption that the input to other subsystems is constant. Therefore, it becomes prone to resulting in either a local optimal or a Nash equilibrium instead of a Pareto optimal set of control inputs. A convergence analysis may be carried out using an investigation of the relationship between communication topology and convergence rate.

For the complicated problem of smart grid control and optimization, hierarchical control is therefore preferred because it decomposes the problem into more manageable units. Centralized control, decentralized control and distributed control may be used in different layers, i.e., in different levels of the hierarchy.

Two-Level Hierarchical Embodiments

Based on the inventors' insights above, various embodiments use a multi-level (e.g., two-level) hierarchical approach that distributes the intelligence among a centralized module and multiple distributed modules. Each of these modules can contain one or several artificial intelligence models, including but not limited to neural networks, reinforcement learning agents, etc. The distributed modules communicate with the center module. In certain embodiments, the distributed modules can also communicate among themselves to achieve one or multiple objective functions. Example of such objective functions include but not limited to generation and demand prediction, operation cost minimization, emissions minimizations, storage lifetime maximization, electric vehicles smart charging, transactive energy market management, etc.

As discussed above, embodiments of the proposed systems and methods for distributed hierarchical artificial intelligence in smart grids operate at two levels. At the higher level in the architecture, an artificial intelligence (AI) center module sits at the high-voltage transmission or distribution substation level, and manages a number of points of aggregations (POA). Each POA can be treated as an aggregated prosumer, capable of injecting or absorbing active and reactive power, performing voltage and frequency regulations, participating in the electricity market, etc. AI center module control and optimization calculates the optimal set-points for each POA based on the information received from upper grid, each POA, and external sources such as independent system operator, weather forecasting stations, etc. The term upper grid usually refers to the bulk transmission/distribution system, with which the grid edge exchanges power.

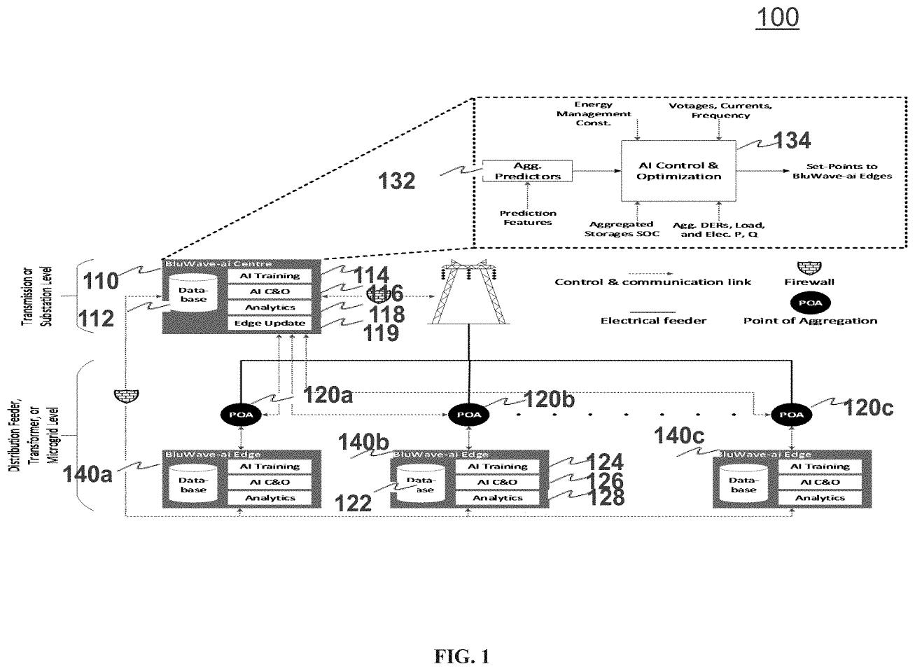

At the lower level in the architecture, each POA consists of all controllable and non-controllable elements at the distribution feeder level, distribution transformer, or microgrid level. These elements include distributed energy resources, energy storage systems, residential and commercial energy management systems, electric vehicle charging stations, etc. As seen in FIG. 1, each POA may be logically and/or physically connected to other POAs. Within each POA, AI edge module control and optimization calculates the optimal disaggregation of set-points received from the AI center module to the controllable elements based on local information, information gathered from the AI center module.

The choice of aggregation points has a significant impact on the efficiency and accuracy of operation, and depends on the number of controllable elements and computation and memory capacity of AI center and edge modules. As mentioned before, the ideal candidates for points of aggregation are at the distribution feeder level, distribution transformation, and microgrid levels.

Although the above discussion focusses on a two-level implementation, other embodiments that include additional intermediary levels consistent with the above description fall within the scope of embodiments of the innovative approach.

FIG. 1 shows a block diagram of an example system 100 for implementing a multi-level distributed hierarchical artificial intelligence system in smart grids, according to some embodiments. System 100 includes AI center module 110 in communication with one or more points of aggregation 120a, 120b, 120c. Points of aggregation 120a, 120b, 120c include respective AI edge modules 140a, 140b, 140c. AI center module 110 includes database 112, AI training module 114, AI control and optimization (C&O) module 116, analytics module 118, and edge update 119. AI center module 110 includes aggregation predictor capability 132, which receives prediction features as input. Aggregation predictor capability 132 output is provided to AI control and optimization capability 116, 134 to provide set points for AI edge modules 140a, 140b, 140c. Other inputs to AI control and optimization capability 116, 134 include energy management information, voltage, current and frequency information, aggregated storage information, and aggregated distributed energy resource (DER), load and other electrical parameters. Edge update 119 updates points of aggregation 120a, 120b, 120c. AI edge module 140 includes database 122, AI training module 124, AI control and optimization (C&O) module 126, and analytics module 128.

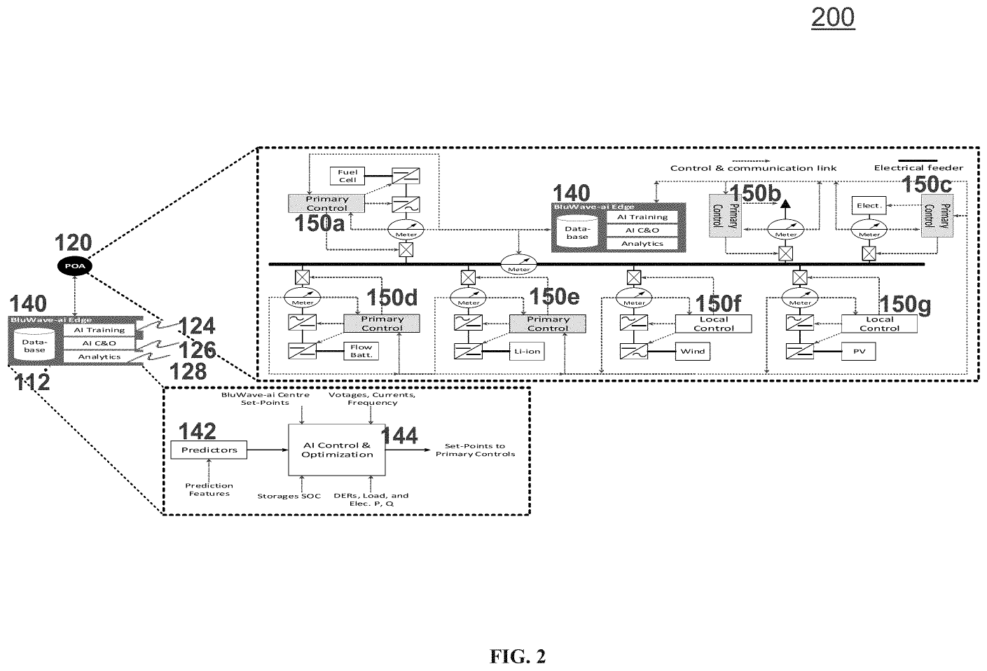

FIG. 2 shows a block diagram of an example system 200 for implementing a multi-level distributed hierarchical artificial intelligence system in smart grids, according to some embodiments. System 200 highlights additional details at AI edge modules 140 at a point of aggregation 120. AI edge module 140 includes database 122, AI training module 124, AI control and optimization (C&O) module 126, and analytics module 128. AI edge module 140 includes aggregation predictor capability 142, which receives prediction features as input. Aggregation predictor capability 142 output is provided to AI control and optimization capability 126, 144 to receive set points from AI center module 110. Other inputs to AI control and optimization capability 126, 144 include voltage, current and frequency information, aggregated storage information, and aggregated distributed energy resource (DER), load and other electrical parameters. AI edge module 140 supports control of one or more energy sources, including fuel cell source 150a, generic energy sources 150b, 150c, flow battery source 150d, lithium-ion battery source 150e, wind energy source 150f, and photovoltaic energy source 150g. AI edge module 140 may have primary control of such energy sources, or its control may be fed via local control (shown for illustrative purposes in wind energy source 150f, and photovoltaic energy source 150g).

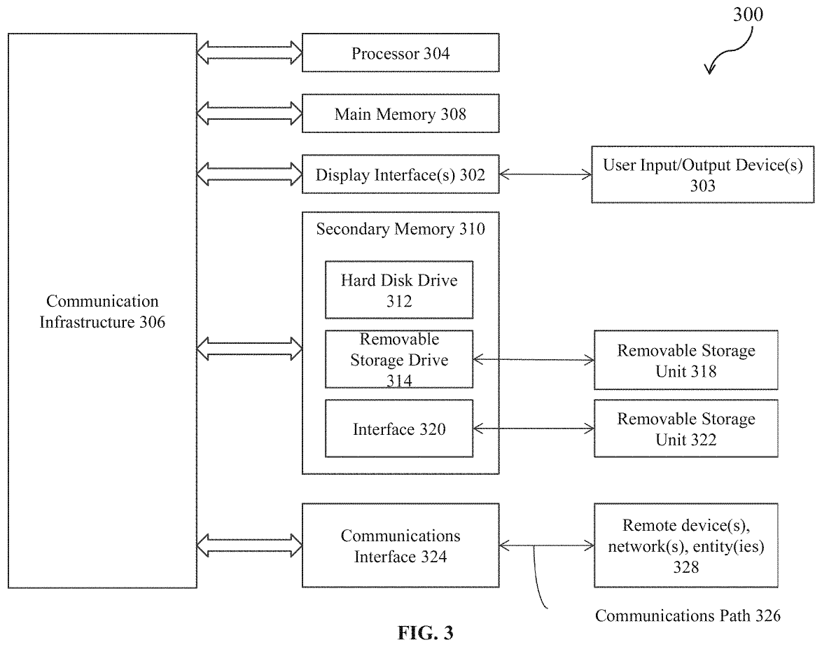

Various embodiments can be implemented, for example, using one or more computer systems, such as computer system 300 shown in FIG. 3. Computer system 300 can be used, for example, to implement the systems and processes described in FIGS. 1 and 2. Computer system 300 can be any computer capable of performing the functions described herein.

Computer system 300 can be any well-known computer capable of performing the functions described herein.

Computer system 300 includes one or more processors (also called central processing units, or CPUs), such as a processor 304. Processor 304 is connected to a communication infrastructure or bus 306.

One or more processors 304 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 also includes user input/output device(s) 303, such as monitors, keyboards, pointing devices, etc., that communicate with communication infrastructure 306 through user input/output interface(s) 302.

Computer system 300 also includes a main or primary memory 308, such as random access memory (RAM). Main memory 308 may include one or more levels of cache. Main memory 308 has stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 includes a computer usable or readable storage device having stored thereon computer software (control logic) and/or data. Removable storage unit 318 may be a floppy disk, magnetic tape, compact disk, DVD, optical storage disk, and/ any other computer data storage device. Removable storage drive 314 reads from and/or writes to removable storage unit 318 in a well-known manner.

According to an exemplary embodiment, secondary memory 310 may include other means, instrumentalities or other approaches for allowing computer programs and/or other instructions and/or data to be accessed by computer system 300. Such means, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 enables computer system 300 to communicate and interact with any combination of remote devices, remote networks, remote entities, etc. (individually and collectively referenced by reference number 328). For example, communication interface 324 may allow computer system 300 to communicate with remote devices 328 over communications path 326, which may be wired and/or wireless, and which may include any combination of LANs, WANs, the Internet, etc. Control logic and/or data may be transmitted to and from computer system 300 via communication path 326.

In an embodiment, a tangible apparatus or article of manufacture comprising a tangible computer useable or readable medium having control logic (software) stored thereon is also referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system for operation of an electric grid, comprising:
an artificial intelligence (AI) center module configured to control a point of aggregation (POA) using information received from at least one of an upper grid, the point of aggregation, and one or more external sources to the electric grid; and
an AI edge module in the POA, wherein the AI edge module is configured to calculate an optimal disaggregation of set points received from the AI center module to one or more controllable elements based on at least one of local information and information from the AI center module.

2. The system of claim 1, wherein the one or more external sources includes an independent system operator.

3. The system of claim 1, wherein the one or more external sources includes a weather forecasting station.

4. The system of claim 1, wherein the AI edge module supports control of one or more of a fuel cell source, a generic energy source, a flow battery source, a lithium-ion battery source, a wind energy source, or a photovoltaic energy source.

5. A method for operation of an electric grid, comprising:
controlling, using an artificial intelligence (AI) center module, a point of aggregation (POA) using information received from at least one of an upper grid, the point of aggregation, and one or more external sources to the electric grid; and
calculating, using an AI edge module in the POA, an optimal disaggregation of set points received from the AI center module to one or more controllable elements based on at least one of local information and information from the AI center module.

6. The method of claim 5, wherein the one or more external sources includes an independent system operator.

7. The method of claim 5, wherein the one or more external sources includes a weather forecasting station.

8. The method of claim 5, wherein the AI edge module supports control of one or more of a fuel cell source, a generic energy source, a flow battery source, a lithium-ion battery source, a wind energy source, or a photovoltaic energy source.

9. A non-transitory computer-readable storage device having instructions stored thereon that, when executed by at least one computing device, cause the at least one computing device to perform operations, comprising:
controlling a point of aggregation (POA) using information received from at least one of an upper grid, the point of aggregation, and one or more external sources to the electric grid; and
calculating an optimal disaggregation of set points received from the AI center module to one or more controllable elements based on at least one of local information and information from the AI center module.

10. The non-transitory computer-readable storage device of claim 9, wherein the one or more external sources includes an independent system operator.

11. The non-transitory computer-readable storage device of claim 9, wherein the one or more external sources includes a weather forecasting station.

12. The non-transitory computer-readable storage device of claim 9, wherein the AI edge module supports control of one or more of a fuel cell source, a generic energy source, a flow battery source, a lithium-ion battery source, a wind energy source, or a photovoltaic energy source.
